(19) United States
(12) Patent Application Publication
(10) Pub. No.: US 2007/0044088 A1
(43) Pub. Date: Feb. 22, 2007

(54) METHOD FOR INSTALLING AT LEAST USER SOFTWARE, AND A ROAD PAVER

(75) Inventor: Achim Eul, Mannheim (DE)

Correspondence Address: DARBY & DARBY P.C., P. O. BOX 5257, NEW YORK, NY, 10150-5257, US

(73) Assignee: Joseph Vogele AG, Mannheim (DE)

(21) Appl. No.: 11/464,395

(22) Filed: Aug. 14, 2006

(30) Foreign Application Priority Data
Aug. 17, 2005 (EP) 05017896.1

(51) Int. Cl. G06F 9/445

(52) U.S. Cl. 717/174

(57) ABSTRACT

A method for installing user software in a host system unit (Z) of an electronic control system of a construction machine, in particular of a road paver (F), the user software and, in addition, in some cases, parameter-base data, completely stored in an external removable storage medium (W) which is designed to be suitable for the coarse conditions in a construction machine. The removable storage medium (W) is attached to a data exchange port (12), which is connected to the host system unit (Z). The user software and, in some cases, the parameter-base data, are transmitted during a start of the system or when attaching the removable storage medium (W) into the host system unit (Z) for installation purposes or for updating purposes. The construction machine is characterized in that a data exchange port (12) is provided at, or within, an operator's console (B), which data exchange port (12) is connected to the host system unit (Z). An external removable storage medium (W), which is built suitable for the coarse conditions in a construction machine, is removably attached at the data exchange port (12). The user software, and, in some cases, the parameter-base data, are stored in the removable storage medium (W) for being transmitted into the host system unit (Z).

The invention relates to a method according to the preamble of claim 1 and to a road paver according to the preamble of claim 4.

Road pavers, as known in practice, include an electronic control device comprising an onboard host system unit, in most cases accommodated in an operator's console, as well as several central or peripheral input/output modules, exterior operator consoles, an engine electronics, a generator electronics and diverse subsystems of sensors and actuators, and the like, which all directly or indirectly are interconnected via a bus system, e.g. at least one field bus. In order to operate the road paver, user software and machine parameter-base data, in most cases, are installed in the storage area of the host system unit. The machine parameter-base data may be the same for different types of machines. Specific data related to the machine or to parameters for casting tracks, which, e.g. are installed for a single type of machine only, are hardly related to the base data and are set or installed in another way. In the case of the first installation, or after a breakdown of the host system unit or of other control units, as well as in case of changes of the user software or of the machine parameter-base data, the data needed for the operation of the road paver are installed by means of a laptop via an interface in a control box on the road paver. This procedure is complicated and needs skilled service personnel. Skilled service personnel is also necessary if the user software and/or the machine parameter-base data have to be changed or updated.

WO 03/055714 A discloses a military vehicle, a concrete mixing vehicle, a snow plough or a garbage truck, which contain an internal bus system in the electronic control system. For installing or updating, and the like, of user software, a PC can be connected via a link to the host system unit. The PC also allows the carrying out of diagnostics processes. However, the PC is only connected, upon demand, for an installation or an updating, or a diagnostics process. These procedures are complicated and require well-trained service personnel.

According to a method as known from US 2005/097541 A, during the assembly of automobiles on an assembly line, software is installed in electronic control systems of the automobiles. In order to eliminate the need to connect a PC or a computer to each of the automobiles, several conventional USB-sticks or USB-flash-discs are loaded with software in a PC or in a computer, then are transported to the automobiles and are temporarily plugged into USB-ports provided there, in order to install the software. This procedure is carried out only upon demand, i.e. for the first time at the assembly line, or later, in case of a service process. A permanent attachment of the sticks or flash discs is not disclosed.

It is an object of the invention to provide a method of the kind as mentioned above, as well as to provide road pavers allowing the carrying out of the installation and/or the updating by personnel which has only little experience or no experience at all.

This object is achieved by the features of claim 1 and of claim 4.

Since, at or in the operator's console, at least one bi-directional data exchange port is provided, which is connected to the host system unit, the installation or updating, at least of the user software in the host system unit, may even be carried out by personnel with little experience, without a time delay, upon demand, or whenever the system is started, and provided that a removable data medium is removably provided at the bi-directional data exchange port, which removable storage medium is external and adapted to meet the coarse requirements on a road paver. The complete user software, and in some cases, the machine parameter-base data stored in the removable storage medium, can be transferred to the host system unit when attaching the removable storage medium or when starting the system. Transferring at least the user software and, expediently, also the machine parameter-base data, into the host system unit, is carried out from the removable storage medium, which is plugged in for this purpose or is already plugged in. In the case that the removable storage medium, e.g. is plugged in during the start of the system, then at least the user software contained in the removable storage medium is transferred into the storage area of the host system unit, and, expediently, also the machine parameter-base data. The transfer of at least the user software, within the control system to all components needing user software, is carried out by the host system unit. The host system unit, e.g. tests, with every start of the system, whether the respective correct software is present in all components and loads, if necessary, the user software, e.g. via a field bus, into the components. This means, that all user programs are held in the host system unit such that, in a service case within the control system, e.g. after replacement of a component, the new component will immediately have access to the correct software. In the case that the removable storage medium is attached during the start of the system, then, automatically, the user software, contained in the removable storage medium, will be transmitted into the host system unit, expediently, then also the machine parameter-base data. This may be also be carried out when the removable storage medium is attached, or upon a command from the host system unit when the removable storage medium is already attached, whenever there is the need for a transfer or for an update. Since the removable storage medium contains the correct user software and/or the machine parameter-base data, in complete form, the installation or the updating can be carried out at any time by personnel without specific experience or skills.

A direct, but releasable plug-in connection is expedient between the data exchange port and the removable storage medium, i.e. a galvanic connection, e.g. in order to allow the attachment of the removable storage medium again, after the operator's console has been replaced.

The removable storage medium is a passive component which cannot be affected by system faults or mechanical breakdowns in the control system, which can be transported comfortably, and which withstands the coarse working conditions on a construction machine without problems.

The removable storage medium, which is adapted to suit the conditions on a road paver, has a robust, preferably substantially cylindrical, outer housing, and a plug.

The road paver includes the removable storage medium as a provided accessory part, to hold ready at least the user software in redundant fashion in case of a system start or in the case of a component replacement. The data is protected and will not be jeopardized by processes occurring in the control system. The installation of the data may even be carried out by unskilled personnel or will be carried out automatically.

In the outer housing, besides at least one micro storage unit, a storage logic is contained.

The outer housing may consist of plastic material and is, preferably, made with reinforcements and/or shieldings, in order to assure high safety and availability of the data.

In a specific embodiment, a gland nut is held at a collar section of the outer housing. The gland nut safeguards and protects a plug-in connection after the removable storage medium has been attached. In some cases, this closure may even be locked.

Expediently, the plug-in connection is safeguarded by a threaded closure or a bayonet closure against accidental or un-authorized releasing manipulations. This also provides a protection against environmental influences.

The removable storage medium, which is prepared at the road paver manufacturer's site, or at a correspondingly equipped service location, and, so to speak, is loaded there, can, without problems, be designed intelligently enough to also allow for the storage of information on diagnostics and for casting tracks. This is done to either transfer this information to the host system unit, or to retrieve this information from the host system unit and to store it. The evaluation of the stored information can then be carried out at any time and at any arbitrarily selected location.

Furthermore, with the use of the removable storage medium, information on diagnostics or for casting tracks may be exported via the data exchange port into the host system unit or may be imported from the host system unit, even by unskilled personnel. This can be carried out automatically or can be commanded by the host system unit.

Provided that a service interface exists at the road paver, which serves the purpose of connecting external diagnostics devices, e.g. service laptops, then the user software, and, expediently, even the parameter-base data, may be updated upon demand in the host system unit by using the respective external diagnostics device.

For this reason, the road paver has, in addition to the data exchange port for the removable storage medium, a diagnostics interface at/within the operator's console, which is connected to the host system unit. The diagnostics interface allows the transmission of data either directly galvanically or in wireless fashion. An external diagnostics device may be connected to the diagnostics interface by the user of this external diagnostics device, and user software, which has at least been installed in the host system unit, may be updated.

Furthermore, with the help of the external diagnostics device, and via the service interface, any information which is available in the control system can be displayed online, in case that this is expedient for testing purposes, for recording purposes or after disturbances. Even this procedure can be carried out by unskilled personnel because the host system unit may be pre-programmed for such a routine. Updating already installed user software and, in some cases, also machine parameter-base data, can be carried out comfortably via the diagnostics interface by using the diagnostics device. Furthermore, if necessary, information for diagnostics and casting tracks, may be exported via the diagnostics interface into the host system unit or may be imported out of the host system unit by unskilled personnel.

Expediently, a wireless data transmission can be carried out via the service interface, preferably corresponding to the standards of DFÜ, Bluetooth or the WLAN, in some cases, even from the outside of the road paver. In order to carry out a wireless data transfer, an apparatus designed for wireless data transmission is provided at the operator's console, such that it is associated with the diagnostics interface. This may be an apparatus according to the standard of DFÜ, Bluetooth or WLAN.

Embodiments of the invention will be explained with the help of the drawings. Shown in the drawing are:

FIG. 1 a side view of a road paver,

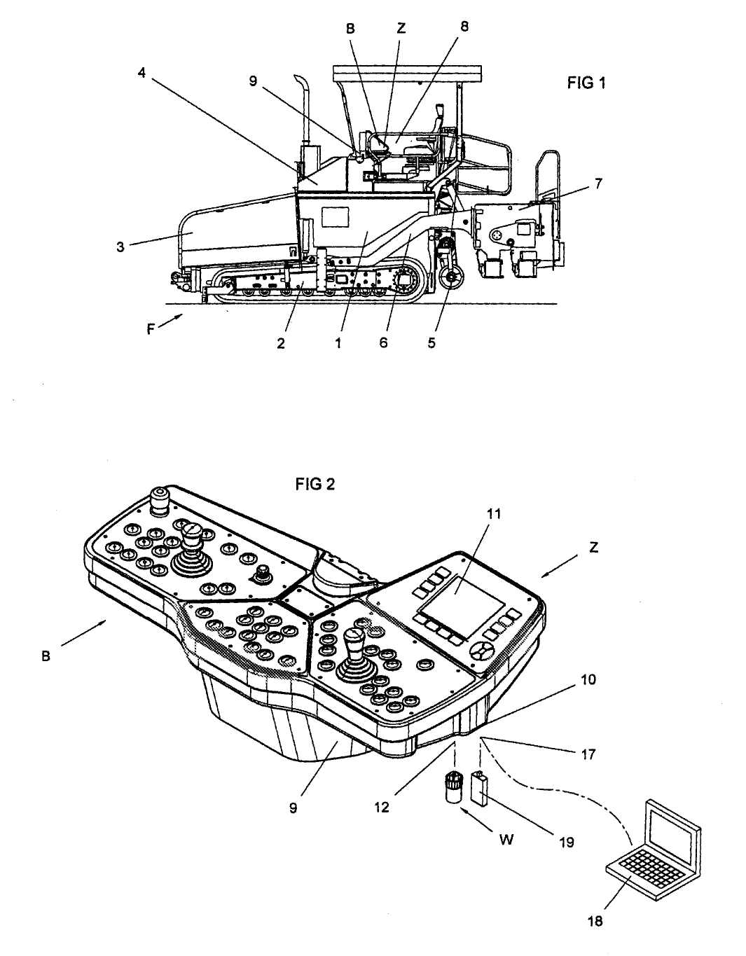

FIG. 2 a perspective detailed view of an operator's console of an electronic control system of the road paver,

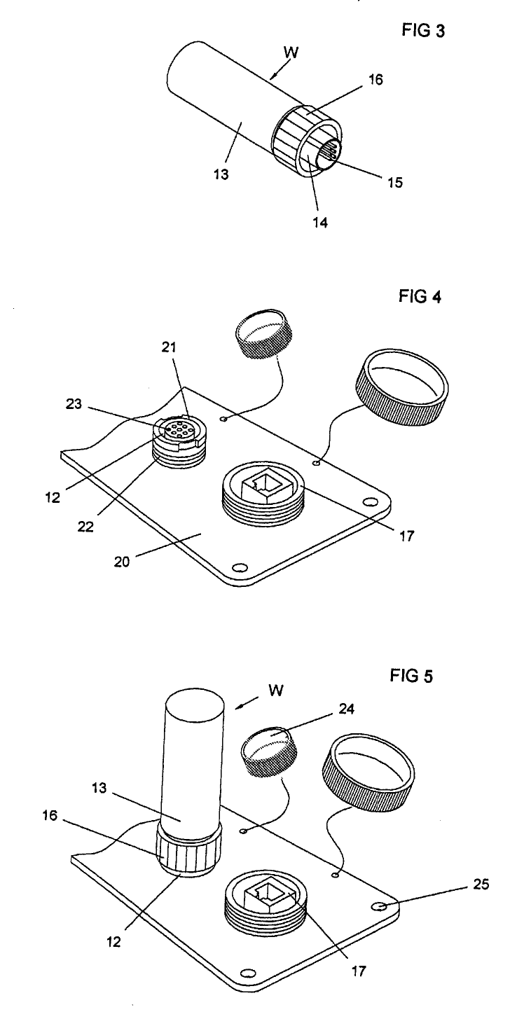

FIG. 3 a perspective view of a removable storage medium,

FIG. 4 a perspective view of a data exchange port for the removable storage medium, and of a service interface, e.g. provided at the operator's console of FIG. 2, and

FIG. 5 the removable storage medium attached to the data exchange port in a condition in which the service interface has been cleared but is not occupied.

FIG. 1 shows a road paver F as an example for a construction machine. The principle of the invention, however, can be applied also to other construction machines like shuttle feeders, graders, road renovating machines, road milling machines, excavators and the like.

The road paver F travels with a chassis 1 on an undercarriage 2 and comprises a front side material hopper 3 behind which a primary drive source 4 is situated. At the rear end of the chassis 1, a lateral distribution device 5 is provided, e.g. an auger mechanism, behind which a paving screed 7 is connected by outriggers 6 to the chassis 1. On the top side of the chassis and behind the primary drive source 4, an operator's stand 8 is provided within which an operator's console B is arranged, accommodating e.g. a host system unit Z of an electronic control device of the road paver F. A transmission path 9 extends from the operator's console B to electric subsystems of the road paver F. The electronic control device contains a bus system, e.g. at least one field bus, to which directly or indirectly, several central or peripheral control units and controller units are connected, which can be programmed in their storage areas, 10-modules, several external operator stands, an engine electronics, a generator electronics, and several subsystems with sensors and actuators. These components of the control system are used for operating the road paver F and, in particular, for control functions, regulating functions and monitoring functions. At least in a storage area of the host system unit Z, user software is stored and, in some cases, also machine parameter-base data. The installation of at least a user software in the control system, and for all components which need the user software, is carried out by the host system unit Z. The host system unit, e.g. tests, during each start of the system, whether the correct user software version is present in all components and then loads, in some cases, the user software via the field bus into the components. This means that all user programs, like the user software and the machine parameter-base data, are held ready in the host system unit, such that, e.g. after replacing a component in case of a service procedure, the needed user software and the machine parameter-base data can be transmitted to the newly installed component.

FIG. 2 is a perspective view of the operator's console B in the operator's stand 8 of FIG. 1. The operator's console B serves to visualize the processes and comprises, beside several actuating elements, an inputting and indication section 11, e.g. including at least one display or a touch screen or the like. The host system unit Z is built into the operator's console B. At the operator's console B, e.g. in a bottom wall 10 (or in the rear wall or a side wall) at a suitable location a data exchange port 12 is provided at which a removable storage medium B is attached in a removable fashion. The removable storage medium W is designed such that it can stand the coarse requirements in a construction machine and contains at least one micro storage unit, and, preferably, a storage logic. The removable storage medium W is mobile and has a handy format with low weight.

The removable storage medium W is connected via the data exchange port 12 with the host system unit Z and contains the user software, and, in some cases, machine parameter-base data, in order to transmit same to the host system unit Z. In the case that the removable storage medium W is attached during the start of the system, then, automatically, at least the user software is transmitted into the host system Z. The transmission can even be triggered by attaching the removable storage medium W, or, alternatively, may be commanded by using the inputting and indicating section 11 as soon as the removable storage medium W is attached properly. This means that an update of the user software, the repeated or the first installation, also of machine parameter-base data, can be carried out at any time and also after a replacement of control system components. The transmission of the user software and of the machine parameter-base data, e.g. can also be carried out by laymen by simply plugging-in the removable storage medium W.

Expediently and furthermore, a service interface 17 is provided at the operator's console B. An external diagnostics device 18 can be connected galvanically to the service interface 17. This external diagnostics device 18 may, e.g., be a service laptop. Alternatively, a wireless data transmission is possible via the service interface 17, provided that an apparatus 19 is provided at the operator's console, which apparatus 19 corresponds e.g. to the standard of DFÜ, Bluetooth or WLAN. Of course, then the diagnostics device 18 has to be equipped accordingly, to allow these wireless data transmissions.

The service interface 17 is connected to the host system unit Z. By using the diagnostics device 18, an updating of the user software can be carried out in the host system unit Z. Furthermore, by means of the diagnostics device 18, information for diagnostic purposes or for casting tracks can be imported into the control system or can be exported from the control system, respectively. Additionally, the service interface 17, in combination with the external diagnostics device 18, can be used for an online visualization of all information which is available in the control system.

The removable storage medium W, in FIG. 3, has a robust, e.g. substantially cylindrical, outer housing 13, made from e.g. plastic material, which has been specifically designed in view of the coarse conditions in a construction machine. The outer housing 13 contains at least one micro storage unit in a protected condition, and, in some cases, also the respective storage logic. In some cases, the outer housing 13 may contain reinforcements and/or a shielding. At one end of the outer housing, a plug 14 is formed where connecting contacts 15 are situated. Further expediently, a gland nut 13 is rotatably secured at the outer housing 13, which serves to safeguard and protect the plug-in connection after mounting the removable storage medium W at the data exchange port 12, and after tightening the gland nut 16. In some cases, the gland nut 16 can be locked. A bayonet closure system or a snap-bracket closure system may be used instead of a threaded connection.

A covering plate 20 is secured in FIG. 4, e.g. in a rear wall or a bottom wall 10 (or a side wall ) of the operator's console B, e.g. by fastening screws. The data exchange port 12, which is formed as a plug-in connection with wrap connections 23, and also the service interface 17, are placed in the covering plate 20, e.g. close to each other. In order to protect the wrap connections 23 and the plug-in connection, a protective collar 21, having an outer thread 22, is provided for the gland nut 16. The service interface 17 is formed in a similar fashion, however, expediently is dimensioned larger or smaller, in order to prevent an accidental incorrect installation of the removable storage medium W.

FIG. 5 shows the removable storage medium W in the attached condition, and safeguarded by the gland nut 16. A protective cap 24, which is threaded onto the protective collar 21 when the data exchange port 12 is not in use, is removed. The covering plate 20 can be secured by fastening elements 25, such that, in the case of a service, it can be disassembled and can then again be mounted onto the new replacement component.

The data exchange port 12, for the removable storage medium W, and also the service interface 17, could instead be placed at another suitable position within the road paver F, e.g. on an electronic box of the electronic control device. In case of a replacement of the operator's console, together with the host system unit, the same or another removable storage medium W is plugged-in into the new operator's console in order to transfer the user software and/or the machine parameter-base data when the removable storage medium W is plugged-in, or when the system is started or upon a command by the host system unit C, respectively. Furthermore, the removable storage medium W may be additionally designed to also be capable of storing information from the control system regarding diagnostics or casting tracks by the road paver. Such information, related to diagnostics or to the casting process of tracks, may either be exported via the data exchange port 12 into the host system unit Z or the control system, respectively, or may be imported out of the host system unit Z or the control system, respectively.

1. Method for installing at least user software in a host system unit (Z) of an electronic control system of a road paver (F), characterized by the following steps:
a micro storage unit and a plug (14) are incorporated into a reinforced and/or shielded outer housing (13) of an external, removable mobile storage medium (P) which is built to withstand and suit the coarse working conditions on road pavers,
the complete user software and, in some cases, parameter-base data, are loaded and stored in the removable storage medium (W) at the site of the road paver manufacturer or at a service location,
the loaded removable storage medium (W) is transported to the road paver (F) and is attached with the plug (14) at a data exchange port (12), which is connected to the host system unit (Z) and is provided for attaching the removable storage medium,
either in case of a start of the system or when attaching the removable storage medium (W) at the data exchange port (12), the user software and, in some cases, the parameter-base data, are transferred into the host system unit (Z) for installation purposes or for updating purposes.

2. Method according to claim 1, characterized in that additionally loaded information data, related to diagnostics or to a process of casting tracks, are transmitted from the removable storage medium (W) into the host system unit (Z).

3. Method according to claim 1, characterized in that information data related to diagnostics or to the process of casting tracks, which has already been stored in or obtained by the host system unit (Z), is transmitted into the removable storage medium (W) in case of a start of the system or when attaching the removable storage medium (W).

4. Road paver (F), having an electronic control system comprising an operator's console (B) including an inputting and indicating section (11), a host system unit (Z) with a central data storing area, and a bus system to which electronic sub-systems are connected for actuating and/or monitoring of function components by use of user software and, in some cases, of parameter-base data, as installed in the host system unit (Z), characterized in that at, or within, the operator's console (B) at least one bi-directional data exchange port (12) is provided which is connected to the host system unit (Z), and that an external removable mobile storage medium (W) is removably attached to the data exchange port (12), which removable storage medium (W) is built with a reinforced and/or shielded outer housing (13), a plug (14), and an incorporated micro storage unit suitable for the coarse conditions in road pavers, and that the complete user software and, in some cases, the parameter-base data, are stored in the removable storage medium (W) and are transmitted into the host system unit (Z) for installing or updating purposes when the removable storage medium is attached or when the system is started.

5. Road paver according to claim 4, characterized in that the outer housing (13) of the removable storage medium (P) additionally accommodates a storage logic.

6. Road paver according to claim 4, characterized in that the outer housing (13) is substantially cylindrical and preferably made of plastic material, and that the plastic material of the outer housing (13) contains a reinforcement against mechanical loads and/or a shielding against a data-loss.

7. Road paver according to claim 4, characterized in that a gland nut (16) is held at a collar section of the outer housing (13), and that at a protecting collar of the data exchange port (12) a gland nut counter thread is provided.

8. Road paver according to claim 4, characterized in that the micro storage unit and the storage logic of the removable storage medium (W) are additionally equipped for storing information data related to diagnostics or the process of casting tracks.

9. Road paver according to claim 4, characterized in that the plug-in connection is safeguarded by a threaded closure or a bayonet closure.

10. Road paver according to claim 4, characterized in that at or within the operator's console (B) and, in addition, the data exchange port (12), a diagnostics interface (17), which is connected to the host system unit (Z), is provided for a direct or a wireless data transmission to an external diagnostics device (18), and that the external diagnostics device (18) is connected to the diagnostics interface (17) for updating user software already previously installed in the host system unit (Z).

11. Road paver according to claim 10, characterized in that an apparatus (19) for a wireless data transmission is arranged at the operator's console (B) and is associated with the diagnostics interface (17), preferably an apparatus according to the standard of DFÜ or Bluetooth or WLAN.

12. Road paver according to claim 10, characterized in that information related to diagnostics or the process of casting tracks, is exported with the help of the diagnostics device (18) via the diagnostics interface (17) into the host system unit (Z) or is imported out of the host system unit (Z).
